(19) United States
(12) Patent Application Publication
(10) Pub. No.: US 2009/0151117 A1
(43) Pub. Date: Jun. 18, 2009

(54) Variable friction hinge

(75) Inventor: Po-Chuan Chen, Shulin City (TW)

Correspondence Address: Joe McKinney Muncy, PO Box 1364, Fairfax, VA, 22038-1364, US

(73) Assignee: SHIN ZU SHING CO., LTD.

(21) Appl. No.: 12/000,392

(22) Filed: Dec. 12, 2007

(51) Int. Cl. E05F 1/08

(52) U.S. Cl. 16/298

(57) ABSTRACT

A variable friction hinge has a pintle, a stationary leaf and a washer assembly. The pintle is attached securely to a cover of an electronic device. The stationary leaf is attached securely to a base of the electronic device. The washer assembly is mounted around the pintle and has a stationary abrasion washer and a rotating abrasion stationary washer. The rotating abrasion washer has an eccentric hole engaging the pintle. With the eccentric hole engaging the pintle, the rotating abrasion washer alternatively rubs fully or partially against the stationary abrasion washer. Therefore, the hinge provides variable friction.

### BACKGROUND OF THE INVENTION

1. Field of the Invention

The present invention relates to a hinge, especially to a variable friction hinge being mounted between a cover and a base of an electronic device to provide different friction when the cover is opened or closed.

2. Description of the Prior Arts

Electronic devices such as notebook computers, cell phones and the like have a cover with a display and a base. A hinge is mounted between the cover and the base to allow the cover to be pivoted relative to the base. The hinge provides friction when the cover is pivoted to the base to maintain the cover at any desired angle. However, the conventional hinge provides the same friction during the cover opening and closing. Thus, when the cover is closed relative to the base, the user needs to offer more force to prevent the cover from gaining momentum and bumping into the base and causing damage. Further, when the cover is opened relative to the base, the user needs to offer more force to allow the cover to be opened quickly and easily and give access to the electronic device faster. Therefore the conventional hinge that provides the same friction during the cover opening and closing is inconvenient.

To overcome the shortcomings, the present invention provides a hinge with variable friction to mitigate or obviate the aforementioned problems.

### SUMMARY OF THE INVENTION

The main objective of the present invention is to provide a variable friction hinge to allow a cover of an electronic device to have different opening and closing resistances. The variable friction hinge has a pintle, a stationary leaf and a washer assembly. The pintle is attached securely to the cover. The stationary leaf is attached securely to a base of the electronic device. The washer assembly is mounted around the pintle and has a stationary abrasion washer and a rotating abrasion stationary washer. The rotating abrasion washer has an eccentric hole engaging the pintle. With the eccentric hole engaging the pintle, the rotating abrasion washer alternatively rubs fully or partially against the stationary abrasion washer. Therefore, the hinge provides variable friction.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a variable friction hinge in accordance with the present invention;

FIG. 2 is an exploded perspective view of the hinge in FIG. 1;

FIG. 3 is another exploded perspective view of the hinge in FIG. 1;

FIG. 4 is an operational end view in partial section of the hinge in FIG. 1 when closed; and

FIG. 5 is an operational end view in partial section of the hinge in FIG. 1 when opened.

### DETAILED DESCRIPTION OF THE PREFERRED EMBODIMENTS

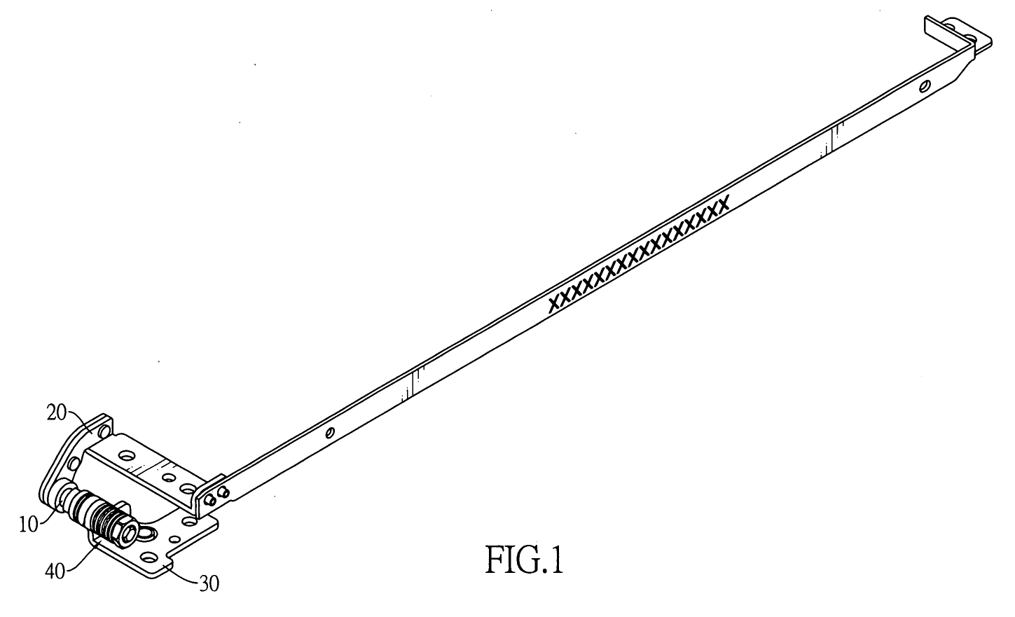

With reference to FIG. 1, a variable friction hinge in accordance with the present invention comprises a pintle (10), an optional rotating leaf (20), a stationary leaf (30) and a washer assembly (40).

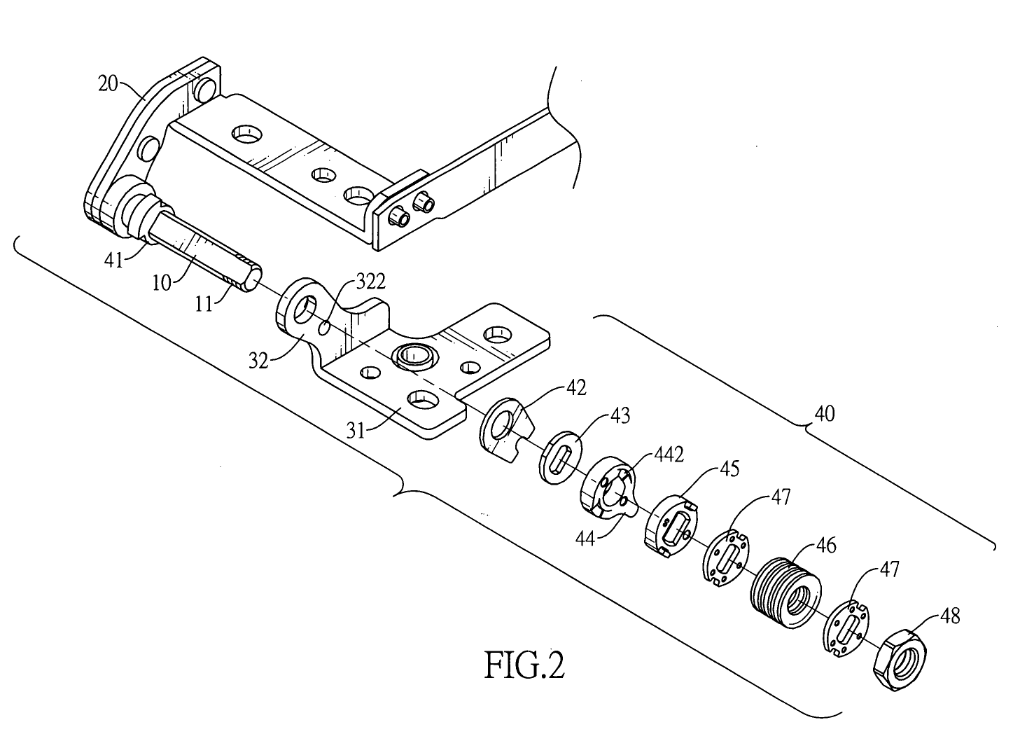

With further reference to FIG. 2, the pintle (10) is non-circular in cross section and has a proximal end, a distal end and an optional threaded segment (11). The threaded segment (11) is formed around the distal end of the pintle (10).

The rotating leaf (20) is attached securely to the proximal end of the pintle (10).

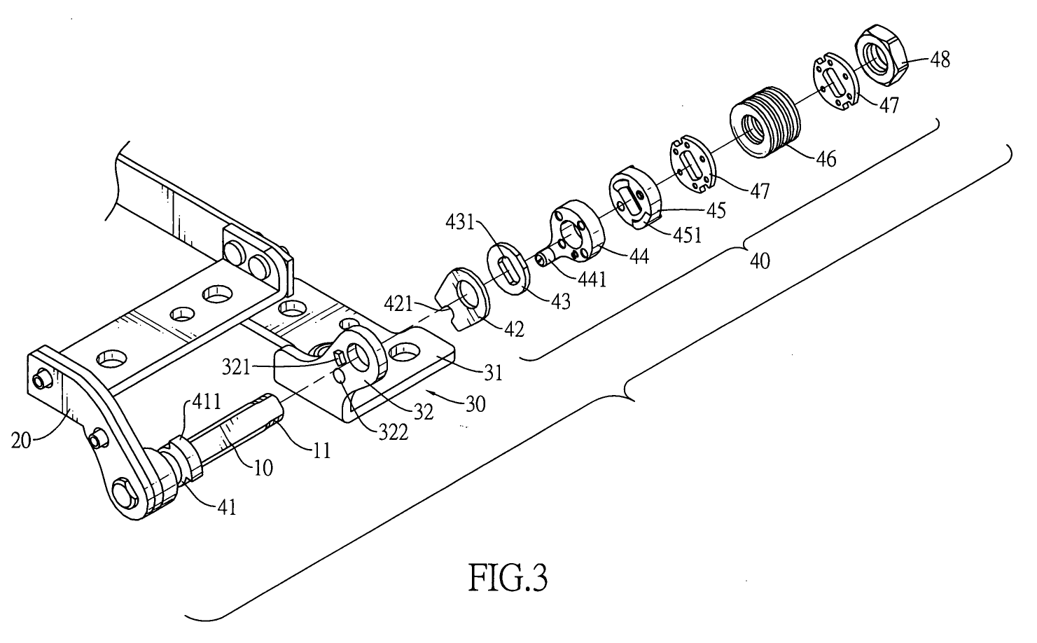

With further reference to FIG. 3, the stationary leaf (30) is connected to the pintle (10) and has a main panel (31) and a mounting panel (32). The mounting panel (32) is formed perpendicularly on the main panel (31), is mounted rotatably around the pintle (10) and has an inner surface, an outer surface, an optional stop (321) and an optional fastening hole (322). The stop (321) is formed on and protrudes out from the outer surface of the mounting panel (32). The fastening hole (322) is formed through the mounting panel (32).

The washer assembly (40) is mounted around the pintle (10) and has an optional limiting washer (41), a stationary abrasion washer (42), a rotating abrasion washer (43), an optional stationary positioning washer (44), an optional rotating positioning washer (45), an optional biasing member (46), multiple optional rubbing washers (47) and a fastener (48).

The limiting washer (41) is mounted securely on the pintle (10) adjacent to the outer surface of the mounting panel (32) and has an annular edge and a limit (411). The limit (411) is formed on and protrudes transversely out from the annular edge of the limiting washer (41) and corresponds to and selectively abuts the stop (321) on the mounting panel (32) to limit the rotating angle of the pintle (10).

The stationary abrasion washer (42) is mounted around the pintle (10), may be attached securely to the mounting panel (32) and may have an edge and a fastening detent (421). The fastening detent (421) is formed transversely in the edge of the stationary abrasion washer (42) and aligns with the fastening hole (322) of the mounting panel (32).

The rotating abrasion washer (43) is mounted securely around the pintle (10) and has a center and an eccentric hole (431). The eccentric hole (431) is non-circular, engages the pintle (10) and has a center. The center of the eccentric hole (431) misaligns with the center of the rotating abrasion washer (43).

The stationary positioning washer (44) is mounted around the pintle (10), is connected securely to the mounting panel (32) and has an outer surface, an inner surface, a fastening protrusion (441) and at least one positioning detent (442). The fastening protrusion (441) is formed on and protrudes out from the outer surface of the stationary positioning washer (44) and is mounted securely in the fastening detent (421) of the stationary abrasion washer (42) and the fastening hole (322) of the mounting panel (32). The positioning detent (442) is formed in the inner surface of the stationary positioning washer (44).

The rotating positioning washer (45) is mounted securely on the pintle (10) and has an inner surface, an outer surface and at least one positioning protrusion (451). The positioning protrusion (451) is formed on and protrudes from the outer surface of the rotating positioning washer (45) and corresponds to and selectively engages the positioning detent (442) of the stationary positioning washer (44) to provide preferred preset positions.

The biasing member (46) is mounted around the pintle (10) to provide a resistive force.

The rubbing washers (47) are mounted around the pintle (10) to reduce friction.

The fastener (48) is mounted securely on the distal end of the pintle (10) and may be a nut screwed onto the threaded segment (11) of the pintle (10).

The hinge as described is mounted between a cover and a base of an electronic device. The pintle (10) or the rotating leaf (20) is connected to the cover. The stationary leaf (30) is connected to the base. When the cover is pivoted relative to the base, the pintle (10) is rotated relative to the stationary leaf (30). Because the rotating abrasion washer (43) is mounted securely around the pintle (10), the rotating abrasion washer (43) is rotated relative to the stationary abrasion washer (42).

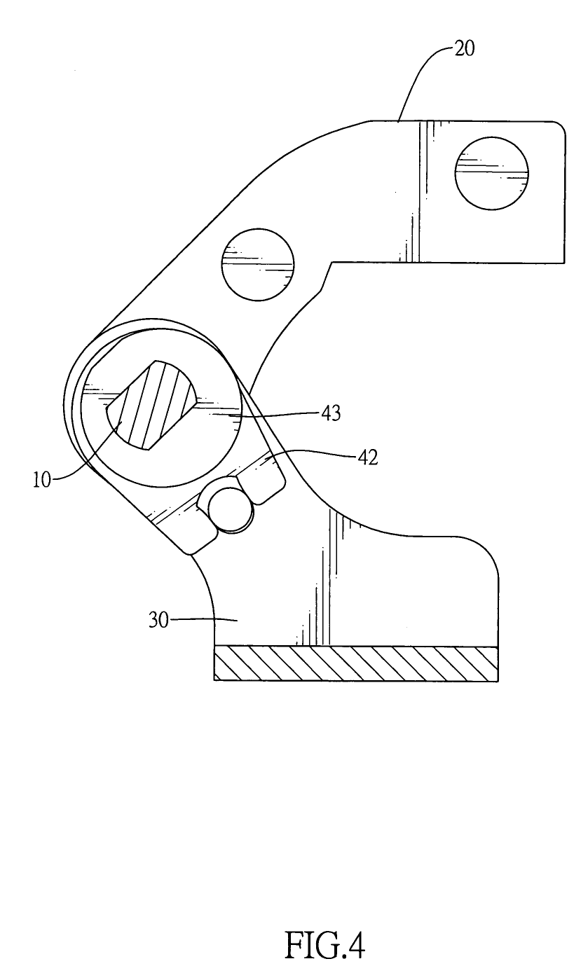

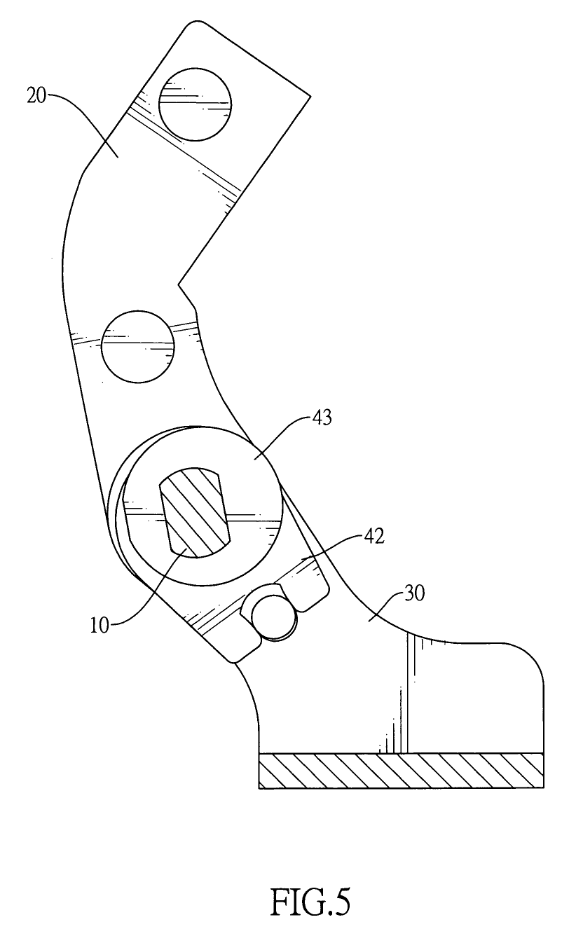

With further reference to FIGS. 4 and 5, the cover is pivoted relative to the base. Because the eccentric hole (431) of the rotating abrasion washer (43) engages the pintle (10), the rotating abrasion washer (43) is rotated with the center of the eccentric hole (431). Because the center of the eccentric hole (431) misaligns with the center of the rotating abrasion washer (43), the distances between the center of the eccentric hole (431) to each point of the annular edge of rotating abrasion washer (43) are different. Therefore, the rotating abrasion washer (43) alternatively rubs fully or partially against the stationary abrasion washer (42). When the rotating abrasion washer (43) fully rubs against the stationary washer (42), the hinge as described provides more friction than when the rotating abrasion washer (43) partially rubs against the stationary washer (42). Thus, the hinge as described provides variable friction to allow the cover being opened quickly and closed slowly.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A variable friction hinge comprising:
a pintle being non-circular in cross section and having a proximal end and a distal end;
a stationary leaf being connected to the pintle and having
a main panel; and
a mounting panel being formed perpendicularly on the main panel, being mounted rotatably around the pintle and having an inner surface and an outer surface; and
a washer assembly being mounted around the pintle and having
a stationary abrasion washer being mounted around the pintle;
a rotating abrasion washer being mounted securely around the pintle and having
a center; and
an eccentric hole being non-circular, engaging the pintle and having a center misaligning with the center of the rotating abrasion washer; and
a fastener being mounted securely on the distal end of the pintle.

2. The variable friction hinge as claimed in claim 1, wherein the washer assembly further has a biasing member being mounted around the pintle.

3. The variable friction hinge as claimed in claim 1 further comprising a rotating leaf being attached securely to the proximal end of the pintle.

4. The variable friction hinge as claimed in claim 2 further comprising a rotating leaf being attached securely to the proximal end of the pintle.

5. The variable friction hinge as claimed in claim 2, wherein the washer assembly further has
a stationary positioning washer being mounted around the pintle, being connected securely to the mounting panel and having
an outer surface;
an inner surface; and
at least one positioning detent being formed in the inner surface of the stationary positioning washer; and
a rotating positioning washer being mounted securely on the pintle and having
an inner surface;
an outer surface; and
at least one positioning protrusion being formed on and protruding from the outer surface of the rotating positioning washer and corresponding to and selectively engaging the at least one positioning detent of the stationary positioning washer.

6. The variable friction hinge as claimed in claim 4, wherein the washer assembly further has
a stationary positioning washer being mounted around the pintle, being connected securely to the mounting panel and having
an outer surface;
an inner surface; and
at least one positioning detent being formed in the inner surface of the stationary positioning washer; and
a rotating positioning washer being mounted securely on the pintle and having
an inner surface;
an outer surface; and
at least one positioning protrusion being formed on and protruding from the outer surface of the rotating positioning washer and corresponding to and selectively engaging the at least one positioning detent of the stationary positioning washer.

7. The variable friction hinge as claimed in claim 5, wherein
the mounting panel has a fastening hole being formed through the mounting panel;
the stationary abrasion washer has
an edge; and
a fastening detent being formed transversely in the edge of the stationary abrasion washer and aligning with the fastening hole of the mounting panel; and
the stationary positioning washer has a fastening protrusion being formed on and protruding out from the outer surface of the stationary positioning washer and being mounted securely in the fastening detent of the stationary abrasion washer and the fastening hole of the mounting panel.

8. The variable friction hinge as claimed in claim 6, wherein
the mounting panel has a fastening hole being formed through the mounting panel;
the stationary abrasion washer has
an edge; and
a fastening detent being formed transversely in the edge of the stationary abrasion washer and aligning with the fastening hole of the mounting panel; and
the stationary positioning washer has a fastening protrusion being formed on and protruding out from the outer surface of the stationary positioning washer and being mounted securely in the fastening detent of the stationary abrasion washer and the fastening hole of the mounting panel.

9. The variable friction washer as claimed in claim 1, wherein
the mounting panel further has a stop being formed on and protruding out from the outer surface of the mounting panel; and
the washer assembly further has a limiting washer being mounted securely on the pintle adjacent to the outer surface of the mounting panel and having
an annular edge; and
a limit being formed on and protruding transversely out from the annular edge of the limiting washer and corresponding to and selectively abutting the stop on the mounting panel.

10. The variable friction washer as claimed in claim 8, wherein
the mounting panel further has a stop being formed on and protruding out from the outer surface of the mounting panel; and
the washer assembly further has a limiting washer being mounted securely on the pintle adjacent to the outer surface of the mounting panel and having
an annular edge; and
a limit being formed on and protruding transversely out from the annular edge of the limiting washer and corresponding to and selectively abutting the stop on the mounting panel.

11. The variable friction hinge as claimed in claim 1, wherein the washer assembly further has multiple rubbing washers being mounted around the pintle.

12. The variable friction hinge as claimed in claim 10, wherein the washer assembly further has multiple rubbing washers being mounted around the pintle.

13. The variable friction hinge as claimed in claim 1, wherein
the pintle further has a threaded segment being formed around the distal end of the pintle; and
the fastener of the washer assembly is a nut being screwed onto the threaded segment of the pintle.

14. The variable friction hinge as claimed in claim 12, wherein
the pintle further has a threaded segment being formed around the distal end of the pintle; and
the fastener of the washer assembly is a nut being screwed onto the threaded segment of the pintle.
